(19) United States
(12) Patent Application Publication
(10) Pub. No.: US 2022/0067775 A1
(43) Pub. Date: Mar. 3, 2022

(54) SYSTEMS AND METHODS FOR USE IN EVALUATING NETWORK INTERACTIONS

(71) Applicant: MASTERCARD INTERNATIONAL INCORPORATED, PURCHASE, NY (US)

(72) Inventor: Reza Rahimi, Chesterfield, MO (US)

(21) Appl. No.: 17/006,519

(22) Filed: Aug. 28, 2020

(51) Int. Cl. G06Q 30/02; G06Q 20/40

(52) U.S. Cl. CPC G06Q 30/0236; G06Q 20/4012; G06Q 30/0233

(57) ABSTRACT

Systems and methods are described for evaluating network interactions involving rewards. One exemplary computer-implemented method includes receiving, by a directory server, from a plug-in associated with a party, a query related to a network interaction directed to a reward account. The method also includes generating, by the directory server, a score associated with the query, based on a history of the reward account and the detail of the party, determining, by the directory server, whether the score satisfies a threshold, and directing a challenge to a user associated with the reward account, at a communication device associated with the user, in response to the generated score failing to satisfy the threshold. The method then includes transmitting, by the directory server to the plug-in, a reply based on the generated score and/or the response to the challenge, thereby providing additional authentication of the user for the network interaction.

### FIELD

The present disclosure generally relates to systems and methods for use in evaluating network interactions and, more specifically, to systems and methods for use in evaluating network interactions based on parameters associated with user accounts.

### BACKGROUND

This section provides background information related to the present disclosure which is not necessarily prior art.

Users are known to interact with different entities for a variety of different purposes including, for example, those related to commerce. When a user interacts with a merchant entity, for example, to make a purchase, the user may present a credit card to the merchant to fund the purchase. The merchant, in turn, submits a credit card transaction to an issuer of the credit card, through a payment network, to secure authorization of the transaction. Often, the issuer applies fraud prevention techniques to the transaction to determine if the credit card transaction is suspicious, and on that basis, should be declined. In addition, the credit card is sometimes associated with enhanced authentication, whereby an EMV® 3-D Secure protocol, for example, provides an additional security layer for online purchase transactions involving the credit card. In connection therewith, a merchant plug-in (MPI) is integrated at the merchant to initiate an authentication request in response to the transaction, which passes through a directory server associated with the payment network and to an access control server (ACS) associated with the issuer. The ACS authenticates the user based on details of the transaction, or provides an authentication step-up to the user at a communication device associated with the user. When the ACS authenticates the user, an authentication reply is provided back to the MPI, which then includes a corresponding value in the following authorization request for the credit card transaction.

While credit cards are known to be used to purchase products (e.g., goods, services, etc.) from merchants, prepaid and debit accounts are also known to be used for similar interactions. It is further known to accumulate rewards based on the use of credit cards and debit cards, which may then, in turn, be used to fund subsequent purchases of products with the merchant, in cooperation with an issuer.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in evaluating network-based reward interactions between users and merchants;

FIG. 2 is a block diagram of an exemplary computing device that may be used in the system of FIG. 1; and

FIG. 3 is a block diagram of an exemplary method for use in evaluating a network-based reward interaction between a user and a merchant, and which may be implemented in the exemplary system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When transactions for the purchase of products (e.g., goods, services, etc.) employ credit accounts, payment networks and/or issuers involved in the transactions often evaluate the transactions for the potential of fraud. However, when transactions employ reward accounts (e.g., loyalty accounts, etc.) (associated with payment accounts, or not) to purchase products, as compared to credit accounts, fraud evaluations are not completed (or employed), whereby the reward accounts are often targeted by fraudsters. The lack of fraud evaluations for such interactions (particularly when such interactions are in the form of network-based interactions) is often exacerbated by low values held in the reward accounts and/or the common lack of review of reward accounts by users (e.g., infrequently accessed accounts, inattention, dormant accounts, etc.). For example, on average, U.S. households are issued about twenty nine reward accounts and, of those, only twelve of the issued reward accounts are considered active. Further, of such active reward accounts, about thirty-four percent of users actually log-in to check balances at least once every three months, while ten percent of users never check balances.

Uniquely, the systems and methods herein permit for evaluating network requests based on parameters associated with user accounts employed in the requests, independent of whether the requests involve reward accounts or credit accounts. In particular, a score is generated for an interaction, which may or may not include a challenge to a user (e.g., multi-factor protection, etc.), at a mobile device, whereby a score is generated, as an assessment of potential fraud, to provide a basis to permit a reward funded transaction to proceed or not. In this manner, previously un-reviewed transactions are subject to scrutiny, through monitoring and screening of authentication processes, via technology (e.g., enhanced authentication, such as, EMV 3DS 2.0, etc.), or not, etc., whereby reward accounts are protected.

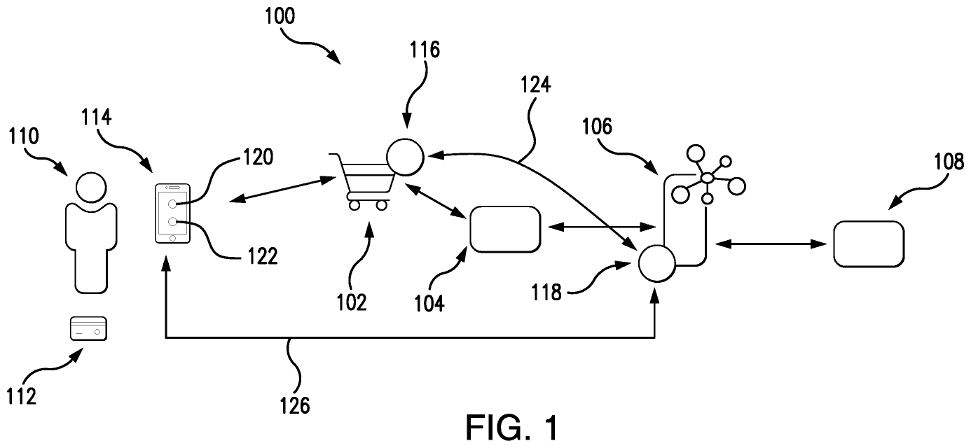

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise depending on, for example, reward accounts used in initiating network requests, processes involved in evaluating network requests to apply rewards, processes involved in evaluating network request for fraud, privacy policies and/or concerns, etc.

As shown in FIG. 1, the illustrated system 100 generally includes a merchant 102, an acquirer 104 associated with the merchant 102, a payment network 106, and an issuer 108 configured to issue payment accounts, each coupled to (and each in communication with) one or more networks, as indicted by the arrowed lines. Each of the one or more networks may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. One or more of the networks may further be segregated or separated, whereby, for example, the segregated or separated network(s) may include a private payment transaction network provided by the payment network 106 to the acquirer 104 and the issuer 108, and separately, a public network (e.g., the Internet, etc.) through which the merchant 102 and/or a user 110 (via a communication device 114 associated with the user 110) communicate, or through which merchant 102 communicates with the acquirer 104, the payment network 106, and/or the issuer 108.

In this exemplary embodiment, the merchant 102 is, at least in part, a virtual merchant, whereby the merchant 102 is accessible to the user 110 through a virtual merchant location, such as, for example, a website or network-based application. In particular in this embodiment, the user 110 interacts with the virtual merchant location via the communication device 114 (e.g., through a web browser accessible at the communication device 114, etc.). In connection therewith, the user 110 is permitted to initiate purchase transactions (broadly, network-based transactions), funded by a payment account (as issued to the user 110 by the issuer 108) or by a reward account (or other rewards in general) associated with the payment account (e.g., miles, dollars, points, etc.) or associated with the merchant 102 (e.g., as accumulated via a merchant loyalty program offered by the merchant 102, etc.), for goods and/or services offered for sale by the merchant 102. With that said, while reference is made to a network-based transaction initiated by the user 110 at a virtual location of the merchant 102, such a network-based transaction may similarly be initiated at a physical brick-and-mortar location of the merchant 102.

The acquirer 104 in the system 100 includes a banking institution or other financial institution, which has issued an account to the merchant 102 into which funds for transactions to the merchant 102 are deposited. The payment account may include, for example, a checking account, a savings account, a credit account, a debit account, a prepaid account, or other suitable type of account, etc.

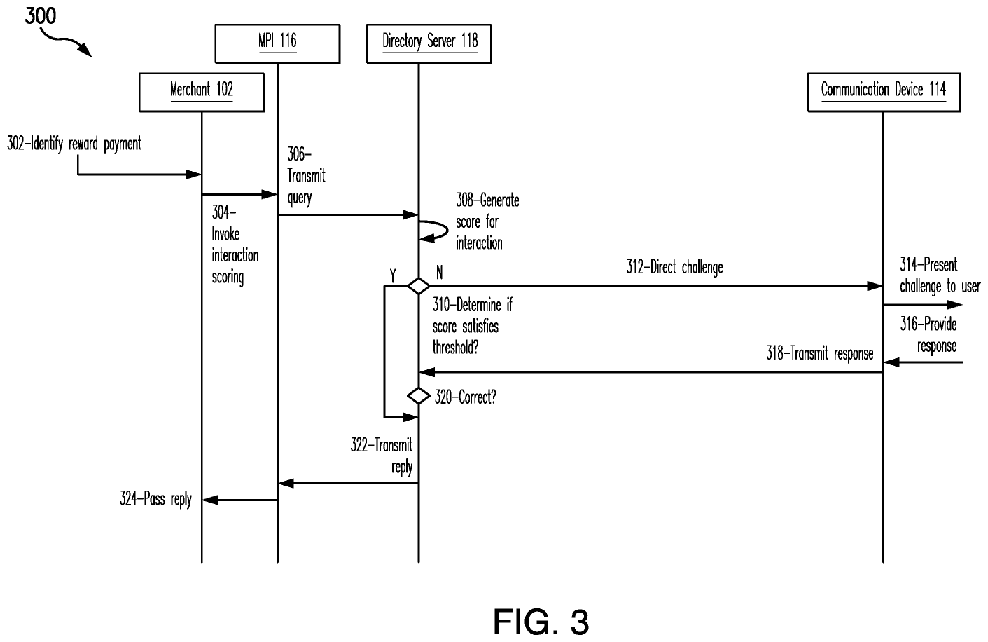

In a similar manner, the issuer 108 includes a banking institution or other financial institution, which has issued the payment account to the user 110, and through which the user 110 is permitted to fund transactions with the merchant 102 and other merchants. When the payment account is issued to the user 110, by the issuer 108, the issuer 108 also provides a payment device 112 to the user 110 whereby the user 110 can use the payment device 112 to initiate transactions to the user's payment account. The payment device 112 includes, in general, a payment card (e.g., a credit card, a debit card, an ATM card, a pre-paid card, or other card device, etc.), which complies with, in this embodiment, the ISO/IEC 7810 ID-1 standard generally indicating the particular physical dimensions and/or dimensional proportions of the payment device 112 (i.e., the payment card in this instance). In addition, the payment device 112 includes a security chip (e.g., an EMV chip, etc.). Of course, however, other payment device embodiments may be constructed according to one or more different standards (other than the ISO/IEC 7810 ID-1 standard). The payment device 112 will be described in more detail hereinafter with reference to FIG. 3.

The payment account issued by the issuer 108 to the user 110 is associated with a rewards feature, whereby the user 110 earns rewards for activities associated with the payment account. For example, the user 110 may earn miles or points or dollars for purchases funded by the payment account, etc. The rewards may be set per dollar spent or per transaction, or may be variable depending on the type of purchase, the amount of the purchase, the category of the merchant involved in the purchase, etc. For example, the user 110 may earn, in general, one point for every dollar spent using his/her payment account, but three points for every dollar spent at a particular merchant within a travel, grocery or restaurant category (e.g., as indicated by a merchant category code (MCC) associated with the merchant, etc.). The rewards may be collected and then converted to cash, for example, and/or spent at one or more different merchants, such as, the merchant 102, etc., to purchase products. Additionally, the user 110 is enrolled in a merchant loyalty program provided by the merchant 102, whereby the user 110 earns rewards (or points) for interactions with the merchant 102 (e.g., for purchases at the merchant 102, etc.). The use of the rewards with the merchant 102, then, to facilities a purchase is described in more detail below.

With continued reference to FIG. 1, the payment network 106 is disposed operatively between the acquirer 104 and the issuer 108 (and other financial institutions) and is configured to facilitate communication therebetween to permit a network-based transaction between the user 110 and the merchant 102 to be authorized, involving either the user's payment account or rewards earned by the user 110 as the means for funding the transaction. The transaction may, for example, be facilitated through an authorization request, generated by the merchant 102 and communicated through the payment network 106 (via the acquirer 104), as described below, where the authorization request generally abides by the ISO 8583 standard. Once the transaction is authorized, by the issuer 108, the payment network 106 is further configured to clear and settle the transaction by and between the acquirer 104 and the issuer 108, whereby funds are transferred to fund the transaction (e.g., from the user's payment account to the merchant's account, from the user's reward account to the merchant's account, etc.).

In addition in this exemplary embodiment, the payment network 106 is configured to enable enhanced authentication of users in connection with e-commerce or online transactions performed by the users (including the user 110) at the merchant 102. This enhanced authentication may include, for example, Secure Code® authentication by Mastercard®. As part thereof, the system 100 further includes a merchant plug-in (MPI) 116 (broadly, a plug-in) (e.g., a 3DS client, etc.) included at and/or associated with the merchant 102, a directory server 118 included at the payment network 106, and optionally, an access control server (ACS) (not shown) included in and/or associated with the issuer 108, where each of the MPI 116, the directory server 118, and the ACS is coupled in communication through one or more of the networks in the system 100, as again indicated by the arrowed lines.

Enhanced authentication in the system 100 includes (or abides by), for example, the EMV® 3-D Secure protocol, whereby, in connection with an e-commerce or online transaction, an authentication request is provided from the MPI 116 to the ACS (via the directory server 118), and an authentication reply is provided back to the MPI 116 (either based on the authentication request or a user challenge question (or step-up)). Apart from such a transaction, the EMV® 3-D Secure protocol may also be employed for a data only interaction, which is described in more detail below. That said, it should be appreciated that other types of enhanced authentication may be implemented in the system 100 in other embodiments.

The user 110 is associated with the communication device 114. In addition to supporting conventional use (e.g., phone calls, short message service (SMS) messages, etc. as is generally understood by those skilled in the art, etc.), the communication device 114 is further configured to access and allow the user 110 to send and/or receive messaging to and/or from the issuer 108 and to communicate with a virtual merchant location of the merchant 102 (via one or more networks, etc.). In connection therewith, the communication device 114 may include, for example, a network-based application 120 associated with and/or provided by the merchant 102 and a separate network-based application 122 associated with and/or provided by the issuer 108 or by an identity provider, either of which configures the communication device 114 to operate as described herein (and which allows such communication with the issuer 108 and merchant 102). It should further be appreciated that the communication device 114 may communicate through one or more networks, including, for example, a cellular or mobile network, a private wireless network, etc. That said, the communication device 114 may include, for example, a smartphone, a tablet, a laptop, or another portable computing device (or other computing device in general), etc.

While one merchant 102, one acquirer 104, one payment network 106, one issuer 108, and one user 110 are illustrated in FIG. 1, it should be appreciated that a different number of merchants (and MPIs), acquirers, payment networks (and directory servers), issuers (and ACSs), and users (and communication devices) may be included in other system embodiments. Further, in still other embodiments, different merchants may have different acquirers, and different users may employ payment accounts issued by multiple different issuers.

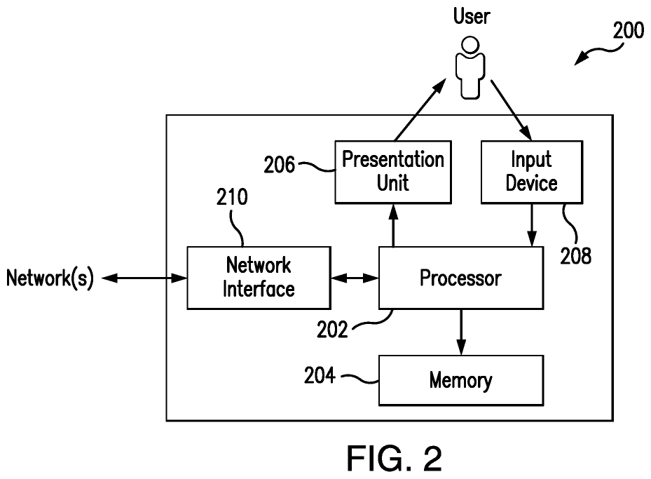

FIG. 2 illustrates an exemplary computing device 200 that can be used in the system 100. The computing device 200 may include, for example, one or more servers, workstations, personal computers, laptops, tablets, smartphones, point-of-sale (POS) terminals, payment devices, etc. In addition, the computing device 200 may include a single computing device, or it may include multiple computing devices located in close proximity to or distributed over a geographic region, so long as the computing devices are specifically configured to function as described herein. In particular, in the exemplary system 100 of FIG. 1, each of the merchant 102, the acquirer 104, the payment network 106, the issuer 108, the MPI 116, and the directory server 118 may include, or may be implemented in, a computing device, such as the computing device 200. In addition, the communication device 114 associated with the user 110 may be considered a computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

With reference now to FIG. 2, the computing device 200 generally includes a processor 202, and a memory 204 that is coupled to (and in communication with) the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may be configured to store, without limitation, transaction data, reward data, other interaction data between users and merchants, and/or other types of data suitable for use as described herein, etc. In addition, the memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. It should be appreciated that the memory 204 may include a variety of different memories. In various embodiments, computer-executable instructions may be stored in the memory 204 for execution by the processor 202 to cause the processor 202 to perform one or more of the operations described herein (e.g., one or more of the operations recited in method 300, etc.), such that the memory 204 is a physical, tangible, and non-transitory computer-readable media and such that the instructions stored in the memory 204, when performing one or more of the operations described herein, enable the computing device to operate as (and thereby transform the computing device into) a specific-purpose device to effect the features described herein.

The computing device 200 also includes a presentation unit 206 and an input device 208 coupled to (and in communication with) the processor 202.

The presentation unit 206 outputs information and/or data to a user (e.g., the user 110, other users, etc.) by, for example, displaying, audibilizing, and/or otherwise outputting the information and/or data. In some embodiments, the presentation unit 206 may comprise a display device such that various interfaces (e.g., webpages, etc.) may be displayed at computing device 200, and in particular at the display device, to display such information and/or data, etc. With that said, the presentation unit 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 206 may include multiple devices in some embodiments. The input device 208, when present in the computing device 200, is configured to receive input from the user 110, for example. The input device may include, without limitation, a keyboard, a mouse, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both the presentation unit 206 and the input device 208.

The illustrated computing device 200 further includes a network interface 210 coupled to (and in communication with) the processor 202 and the memory 204. The network interface 210 may include, without limitation, a wired network adapter, a wireless network adapter, a mobile adapter, or other device capable of communicating to one or more different networks (e.g., the Internet, a private or public LAN, WAN, mobile network, combinations thereof, or other suitable networks, etc.). In some exemplary embodiments, the processor 202 and one or more network interfaces may be incorporated together.

Referring again to FIG. 1, when the user 110 interacts with the merchant 102 to purchase one or more products (e.g., goods, services, etc.), for example, via a virtual location of the merchant 102 or via an application associated with the merchant 102 or otherwise (e.g., whereby the interaction broadly involves a network-based interaction, etc.), the user 110 in this exemplary embodiment, opts to fund the transaction in whole or in part with rewards (or points) earned through the loyalty program provided by the merchant 102. As such, at checkout, the user 110 selects to pay with the rewards (or points) earned in the merchant's loyalty program. Alternatively, the user 110 may opt to fund the transaction in whole or in part with rewards earned through the payment account issued by the issuer 108. Here, at checkout, the user 110 may select the payment account issued by the issuer 108 and then further select to pay with the rewards.

In response, in either case, the merchant 102 is configured to invoke reward interaction scoring through the MPI 116 for the transaction (based on the user's selection to fund the purchase with rewards (or points)). In doing so, the merchant 102 and/or the MPI 116 identifies, for example, the user's account (e.g., based on an account number for the user's reward account with the merchant 102 as provided by the user 110, based on a primary account number (PAN) for the user's payment account from the issuer 108, etc.), an amount of the interaction/transaction, a name of the merchant 102, an identifier of the merchant 102, a location of the interaction/transaction (e.g., a location of the merchant 102, or a designation of a virtual interaction, etc.), a merchant category code (MCC) for the merchant 102, etc. In response, the MPI 116 is configured to submit a query (e.g., different than a conventional authentication request, etc.) to the directory server 118 (as indicated by arrowed line 124) (e.g., via a 3DS requestor environment and/or API/server/browser, etc.) regarding the rewards interaction/transaction (and potentially including at least some of the identified information regarding the interaction/transaction).

In turn, the directory server 118 is configured to access a data structure including an entry for the user's account (e.g., as identified based on the account number for the user's reward account with the merchant 102, as identified based on the PAN for the user's payment account, etc.). The entry includes data related to the user's account, and more specifically, usage of rewards associated with the account. In particular, the entry includes historical interactions for the account regarding use, collection, etc. of rewards, including, for example, transactions funded by rewards, transfers of rewards, conversions of rewards, login activity for the user's reward account, etc. The directory server 118 is configured to then determine a velocity of such reward interactions (e.g., a rate of the user's interaction with the reward account, etc.) and a last interaction by the user 110 with the reward account, etc. Then, the directory server 118 is configured to generate a score for the current interaction based on, in this exemplary embodiment, the determined velocity, an interval since the last interaction, and a location of the interaction (as indicated in the query). It should be appreciated that other data may be employed to determine a score related to a reward interaction by a user at a merchant in other embodiments.

When the score is generated, the directory server 118 is configured to compare the score against one or more thresholds. In response to the score satisfying the one or more thresholds, the directory server 118 is configured to provide a confirmation message back to the MPI 116 (in response to the query) indicating that the interaction is permitted. Conversely, when the score fails to satisfy the one or more thresholds, the directory server 118 is configured to issue a challenge to the user 110 (as indicated by arrowed line 126), either directly based on contact information included in the entry in the data structure, or back through the MPI 116, whereby the merchant 102 is configured to direct, based on an instruction in the message from the directory server 118, the user 110 to an interface with the directory server 118 (and thereby implement a multi-factor authentication procedure). Whether directly or via the instruction, the directory server 118 is configured to solicit data from the user 110, such as, for example, a confirmation, a passcode, a PIN or a biometric, etc. The communication device 114, in turn, is configured to display the solicitation from the directory server 118 to the user 110. And, in response, the user 110 provides, at the communication device 114, an input as solicited, whereupon, the communication device 114 is configured to transmit the same back to the directory server 118. When the input is correct or proper (e.g., a confirmation is provided, or a biometric or PIN is provided matching a reference, etc.), the directory server 118 is configured to provide a confirmation message back to the MPI 116 indicating that the interaction is permitted.

In response, when the interaction is permitted by the directory server 118 (in either of the above scenarios), the MPI 116 is configured to pass the confirmation to the merchant 102, whereupon the merchant 102 is configured to continue in the interaction. In particular, the merchant 102 is configured to apply rewards (or points) from the user's reward account toward funding the transaction/interaction (e.g., whereby the merchant 102 processes the transaction/interaction using credit, etc.).

However, when the input provided by the user 110 is not correct or proper (and/or, potentially, the score satisfies a different threshold, etc.), the directory server 118 is configured to then provide a confirmation message back to the MPI 116 indicating that the interaction is not permitted. In response, when not permitted, the MPI 116 is configured to pass the confirmation to the merchant 102, whereupon the merchant 102 is configured to halt the interaction with the user 110 and/or indicate a decline for suspicion of fraud. Or, the merchant 102 may request payment by the user 110 via the payment account in a conventional manner.

FIG. 3 illustrates an exemplary method 300 of evaluating network requests, for example, for use of rewards (or points) to fund a transaction (or other interaction) with a merchant. The method 300 is described below in connection with the exemplary system 100, and the exemplary computing device 200. However, it should be appreciated that the method 300 is not limited to the system 100 or the computing device 200, but may be implemented in a variety of different systems and/or payment devices and/or computing devices. Likewise, the systems, the payment devices, and the computing devices described herein should not be understood to be limited to the exemplary method 300, or other methods described herein.

Initially in the method 300, in connection with an interaction by the user 110 at the merchant 102 (e.g., to purchase a product, to convert rewards (e.g., miles to points or to dollars, etc.), to check a rewards balance, etc.) the user 110 identifies to the merchant 102, at 302, that rewards are to be used or reviewed as part of the interaction (e.g., the user 110 identifies a reward payment to the merchant 102, the user 110 indicates a reward interaction, the user identifies the user's reward account to the merchant 102, etc.). In general, the user 110 may present a reward account number to the merchant 102 for the user's reward account associated with the merchant's loyalty program. Or, the user 110 may present the payment device 112 to the merchant 102 to initiate the interaction/transaction, whereby the merchant 102 captures a payment account credential (e.g., the PAN, etc.) for the user's payment account, or potentially, a reward account number for the user's reward account at the merchant 102 (as may be associated with the payment account), etc. In addition, or with the presentation of the payment device 112 or reward account number, the user 110 also selects an option to proceed with rewards (rather than use funds or credit available from the payment account). In this exemplary embodiment, the interaction by the user 110 with the merchant 102 is to purchase one or more products using the rewards. That said, when the interaction is otherwise, another entity may stand in place of the merchant 102, including, for example, the acquirer 104, the issuer 108, etc. (e.g., for a reward conversion or balance check, etc.).

When the reward payment is indicated to the merchant 102, as in this exemplary embodiment, the merchant 102 (e.g., as a checkout sequence of the virtual merchant location, etc.) invokes, at 304, reward interaction scoring with the MPI 116. By invoking the scoring, the merchant 102 provides an identifier of the user's reward account and/or the use's payment account (e.g., a PAN, etc.), a detail of the merchant 102 (e.g., a location or identifier of the merchant 102, etc.), contact information for the user 110 (e.g., a phone number for the communication device 114, or application ID for one of the applications 120, 122 included in the communication device 114, etc.), etc.

In turn, the MPI 116 transmits a query, at 306, for the interaction to the directory server 118. The query includes, for example, details of the interaction such as an amount of the desired transaction, a time and date, an identity of the merchant 102, a merchant category (e.g., MCC, etc.) for the merchant 102, a type of rewards to be used, a reward account identifier, a payment account credential (e.g., the PAN for the user's payment account, etc.), the contact information for the user 110, etc.

Upon receipt of the query, the directory server 118 generates, at 308, a score for the interaction. The score may be generated in a number of different ways and may be based on a number of different parameters. For instance, the directory server 118 may access a data structure including interaction data for the reward account of the user 110 linked to the user's payment account (as identified by the PAN in the query, etc.). The interaction data from the data structure may include, for example, a history of interactions by the user 110 involving his/her reward account (e.g., a time and date of such interactions, a reward amount or balance associated with such interactions, etc.), etc. In this way, the directory server 118 is able to determine a velocity of interactions, by the user 110, with the reward account, etc. The interaction data may also include access data, indicating when the user 110 accessed the reward account. For example, the user 110 may login weekly, or monthly, to check a balance, or the user 110 may have not logged in for more than five months or more or less. In connection therewith, the directory server 118 is able to determine a last time the user 110 logged in, or a frequency of logins to the reward account, etc. In addition, the directory server 118 may identify the location of the current interaction, for example, as indicated in the query from the MPI 116. The location may be a physical location, such as, for example, an address of the merchant 102 (e.g., or part thereof (e.g., a postal code, etc.), etc.) or a type of merchant location with which the user 110 is interacting (e.g., a physical location (attended or unattended (e.g., a kiosk, etc.)), a virtual location, etc.). It should be appreciated that the above described data is merely exemplary and that other data may be identified for the particular interaction or the reward account, in general.

In connection therewith, the merchant 102 may transmit or share historical account data for the user's reward account with the directory server 118, for example, as part of implementing enhanced security herein (e.g., as part of implementing a 3-D Secure protocol, etc.) (e.g., directly or via a 3-D Secure server which then shares the data with the directory server 118, etc.), or otherwise (e.g., prior to any interaction by the user 110 with the merchant 102 to fund a transaction using rewards in the reward account, etc.). In this way, the directory server 118 has access to such data (as described above via the data structure) to generate the appropriate scores for the interaction of the user 110 with the merchant 102. In a similar manner, the issuer 108 may transmit or share similar historical data for the user's reward account linked to his/her payment account with the directory server 118, again as part of implementing enhanced security herein or otherwise. The directory server 118 may thus also have access to such reward data (again via the data structure described above) to generate the appropriate scores for an interaction in which the user 110 desires to instead fund a transaction at the merchant 102 with this other reward account.

In this exemplary embodiment, the directory server 118 generates the score (at 308) based on the location of the interaction being a virtual location, the velocity of the user's interactions (or transactions) with the reward account, and a last time the user 110 logged into the reward account. In particular, each parameter or factor is reduced to a numerical value and combined.

As an example, if the user 110 has not accessed his/her reward account with the merchant 102 in the past 90 days, and uses a new IP address at the time of a next login access (as compared to the IP address previously used to access his/her account) (indicating a new location for the user 110), and a type of the transaction with the merchant 102 by the user 110 has not been observed before in the user's reward account (e.g., a network-based transaction versus multiple prior in-person transactions, etc.), the directory server 118 will generate a relatively high risk score based on the lack of recent access to the user's account and the variance of the current transaction from historical transactions. For instance, the directory server 118 may assign a value of 25 for each 30 days the account is not accessed, whereby a value of 75 is assigned in the above example to this factor as the user 110 has not accessed his/her reward account in the past 90 days. The directory server 118 may also assign a value of 300 in the above example based on use of the new IP address (not previously used before), and a value of 300 based on the type of the transaction having not been observed before. Further, the directory server 118 may assign an additional value of 50 for each different factor taken into account in the scoring (i.e., an additional value of 50 for the lack of access to the reward account, an additional value of 50 for the different IP address used, and an additional value of 50 for the different type of transaction performed), for a further value of 150. The directory server 118 then sums the values, in this example, for a final score of 825 (e.g., on a scale of 1-1000, where all scores are capped at 1000; etc.).

As another example, if the user 110 has accessed his/her reward account with the merchant 102 in the past 30 days, but uses a new IP address at the time of a next login access (as compared to the IP address previously used to access his/her account) (indicating a new location for the user 110), and a type of the transaction with the merchant 102 by the user 110 has not been observed before in the user's reward account (e.g., a network-based transaction versus multiple prior in-person transactions, etc.), the directory server 118 will again generate a relatively high risk score based on the variance of the current transaction from historical transactions. For instance, the directory server 118 may again assign a value of 300 in this example based on use of the new IP address (not previously used before), and a value of 300 based on the type of the transaction having not been observed before. Further, the directory server 118 may assign an additional value of 50 for each different factor taken into account in the scoring (i.e., an additional value of 50 for the different IP address used and an additional value of 50 for the different type of transaction performed), for a further value of 100. The directory server 118 then sums the values, in this example, for a final score of 700 (e.g., again on a scale of 1-1000, where all scores are capped at 1000; etc.).

As still another example, if the user 110 has accessed his/her reward account with the merchant 102 multiple times in the past 90 days (and at least once in each 30-day period during the past 90 days) and uses the same IP address at the time of a next login access as used previously to access his/her account), but a type of the transaction with the merchant 102 by the user 110 has not been observed before in the user's reward account (e.g., a network-based transaction versus multiple prior in-person transactions, etc.), the directory server 118 will generate a relatively low risk score. For instance, the directory server 118 may again assign a value of 300 in this example based on the type of the transaction having not been observed before, and an additional value of 50 for each different factor taken into account in the scoring (i.e., an additional value of 50 for the different type of transaction performed). The directory server 118 then sums the values, in this example, for a final score of 350 (e.g., again on a scale of 1-1000, where all scores are capped at 1000; etc.).

As a further example, if the user 110 has not accessed his/her reward account with the merchant 102 in the past 90 days, and uses a new IP address at the time of a next login access (as compared to the IP address previously used to access his/her account) (indicating a new location for the user 110), and a device identifier for the device used a login is different from a device identifier(s) observed/recorded in prior login accesses (indicating the login attempt is through a new device), the directory server 118 will generate a relatively high risk score based on the lack of recent access to the user's account and the login access variance. For instance, the directory server 118 may again assign a value of 25 for each 30 days the account is not accessed, whereby a value of 75 is assigned in the above example to this factor as the user 110 has not accessed his/her reward account in the past 90 days. The directory server 118 may also assign a value of 300 based on use of the new IP address (not previously used before), and a value of 400 based on the use of a new device (not previously used before). Further, the directory server 118 may assign an additional value of 50 for each different factor taken into account in the scoring (i.e., an additional value of 50 for the lack of access to the reward account, an additional value of 50 for the different IP address used, and an additional value of 50 for the different device used), for a further value of 150. The directory server 118 then sums the values, in this example, for a final score of 925 (e.g., again on a scale of 1-1000, where all scores are capped at 1000; etc.).

It should be appreciated that other factors may be taken into account in other examples. In addition, it should be appreciated that different scores may be assigned to the factors in other examples, and that scores for other combinations of factors may be used. Further, it should be appreciated that the individual values may be combined differently in other embodiments to generate the final score (e.g., one or more of the values may be weighted prior to being added to other values to generate the final score, etc.).

With reference again to FIG. 3, the directory server 118 then determines, at 310, whether the generated score satisfies one or more thresholds. For example, in response to the generated score satisfying a threshold, as shown in FIG. 3, the method 300 proceeds as described below. However, when the generated score does not satisfy the threshold, the directory server 118 directs, at 312, a challenge to the user 110 at the communication device 114. In connection therewith, the directory server 118 may provide to the MPI 116 a link to the directory server 118, whereby the communication device 114 is able to access the link to communicate with the directory server 118. Alternatively, the directory server 118 may communicate directly with the communication device 114 based on a phone number known to the directory server 118, or via an application included in the communication device 114 and known to the directory server 118. For example, the communication device 114 may include a digital identity application (e.g., associated with one of the applications 120 and 122, etc.), into which the user' identity is provisioned. And, the directory server 118 may have rights in interrogate the application at the communication device 114 to present the challenge. In either case, the challenge may include providing a PIN or a password known to the user 110, or the challenge may merely request an acceptance of or an acknowledgement of the challenge (thereby indicating the user's possession of the communication device 114), etc. In at least one embodiment, the challenge includes a solicitation of a biometric.

In the above examples, where the directory server 118 generates the risk scores (e.g., the scores of 825, 700, 350, and 925 on the scale of 1-1000, etc.), the directory server may compare the scores to a threshold of 500, for example, in connection with determining whether to direct the challenge to the user 110, or not. As such, since the generated risk scores in the first (i.e., 825), second (i.e., 700), and fourth (i.e., 925) examples are greater than the threshold, it will trigger an authentication challenge (at 312), while the risk score (i.e., 350) in the third example will not. It should be appreciated that other thresholds (and/or combinations of thresholds) may be used in other examples.

When the challenge is received at the communication device 114, the communication device 114 presents, at 314, the challenge to the user 110. This may include displaying the challenge or appending a challenge banner on a screen of the communication device 114. The user 110 will then access the challenge and provide, at 316, a response to the challenge. And, at 318, the communication device 114 provides the response to the directory server 118. In some implementations, the communication device 114 may optionally confirm the response at the communication device (e.g., when the response includes a biometric, etc.), prior to providing the response to the directory server 118.

The directory server 118 then determines, at 320, whether the response is correct, or not. The directory server 118 then transmits, at 322, a reply to the MPI 116. The reply may indicate a satisfactory scoring, either based on the generated score satisfying the threshold (at 310) or based on a correct challenge, or, alternatively, may indicate an un-satisfactory scoring. In at least one embodiment, the method 300 is altered such that the reply includes only the generated score, whereby there is no determination relative to the score, so that the merchant 102 may decide how to proceed based on the score (e.g., as compared to a threshold determined by the merchant 102, etc.). In any event, the directory server 118 does not provide the scoring (or the indication of satisfactory or not), or other result, to any ACS associated with the reward account and/or a payment account associated with the payment account (in this manner, the decision and/or the logic is employed at the directory server 118, and not at the ACS).

When the MPI 116 receives the reply, the MPI 116 passes, at 324, the reply to the merchant 102. When the reply indicates an un-satisfactory scoring, the merchant 102 ends the interaction. Conversely, when the reply indicates a satisfactory scoring, the merchant proceeds in the interaction. Specifically, the merchant 102 is configured to apply rewards (or points) from the user's reward account (as linked to the merchant's loyalty program in this example) toward funding the transaction/interaction (e.g., whereby the merchant 102 processes the transaction/interaction using credit, etc.). However, in at least one scenario (e.g., where the user 110 elects to fund the transaction with the merchant 102 using rewards linked to his/her payment account at the issuer 108 (whereby the reward account is also maintained by the issuer 108), the merchant 102 may compile and transmit an authorization request for the transaction to the issuer 108 (via the acquirer 104 and the payment network 106), In response, the issuer 108 may decide to approve or decline the transaction based on the available rewards in the user's reward account, and transmit an authorization reply back to the merchant 102 based therein (following a conventional four-party approach).

In view of the above, the systems and methods herein provide a new and unique architecture for addressing, and inhibiting, fraudulent interactions involving loyalty accounts (e.g., as provided by merchants to their customers, etc.) and corresponding rewards. In connection therewith, the systems and methods herein provide an intelligent workflow that involves monitoring and screening user authentication processes, for instance, via the EMV 3D S 2.0 rail (e.g., consistent with the EMV 3DS 2.0 data only specification, etc.), whereby data elements from the users, their devices, and the merchants involved in the interactions are collected/generated and transmitted through a risk based authentication model (e.g., implemented in the directory server 118, etc.), which then focusses scoring for the interaction(s) on nonpayment data attributes of the collected/generated elements. The generated score then provides a basis to approve authentication of the user (and underlying reward interaction) or trigger a challenge using multi-factor procedures, based on comparison to one or more thresholds, etc. In this manner, the data and score generation for the reward transaction is layered on top of existing technology (e.g., the MPI, the directory server, etc.) (e.g., but omitting an access control server (ACS) from the conventional authentication scheme, etc.), thereby extending and/or enhancing functionality and purpose of the existing technology.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) receiving, by a directory server, from a plug-in (e.g., a merchant plug-in (MPI), etc.) associated with a party, a query related to a reward interaction (e.g., a network-based reward interaction, etc.) directed to a reward account, the query including an identifier associated with the reward account and a detail of the party involved in the reward interaction; (b) generating, by the directory server, a score associated with the query, based on a history of the reward account and the detail of the party; (c) determining, by the directory server, whether the score satisfies a threshold; (d) directing a challenge to a user associated with the reward account, at a communication device associated with the user, in response to the generated score failing to satisfy the threshold; (e) transmitting, by the directory server to the plug-in, a reply based on the generated score and/or the response to the challenge, thereby providing additional (or enhanced) authentication of the user for the reward interaction directed to the reward account of the user; (f) receiving, by the directory server, the history of the reward account from the party prior to receiving the query from the plug-in; and (g) storing the received history of the reward account in a data structure.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in evaluating network interactions, the method comprising:
receiving, by a directory server, from a merchant plug-in (MPI) associated with a merchant, a query related to a network interaction directed to a reward account, the query including an identifier associated with the reward account and a detail of the merchant involved in the network interaction;
generating, by the directory server, a score associated with the query, based on a history of the reward account and the detail of the merchant, wherein the history of the reward account includes a history of interactions involving the reward account and a history of access by the user to the reward account;
determining, by the directory server, whether the score satisfies a threshold;
directing a challenge to a user associated with the reward account, at a communication device associated with the user, in response to the generated score failing to satisfy the threshold; and
transmitting, by the directory server to the MPI, a reply based on the generated score and/or the response to the challenge, thereby providing additional authentication of the user for the network interaction directed to the reward account of the user.

2. The computer-implemented method of claim 1, wherein the query further includes a contact for the user; and
wherein directing the challenge to the user includes directing the challenge to the user based on the contact included in the query.

3. The computer-implemented method of claim 1, wherein generating the score includes generating the score based on a velocity of interactions to the reward account and a last login by the user to the reward account.

4. The computer-implemented method of claim 3, wherein generating the score is further based on a type of the network interaction as indicated by the detail of the merchant.

5. The computer-implemented method of claim 1, wherein the challenge includes a request for a PIN or password associated with the user; and
further comprising determining, by the directory server, whether the PIN or password provided by the user is consistent with a reference PIN or password for the user.

6. The computer-implemented method of claim 1, wherein the query includes a data only request consistent with an EMV® 3-D Secure protocol.

7. The computer-implemented method of claim 1, further comprising:
receiving, by the directory server, the history of the reward account from the merchant prior to receiving the query from the MPI; and
storing the received history of the reward account in a data structure.

8. The computer-implemented method of claim 1, further comprising receiving, by the MPI, a request for the score from the merchant, in response to an indication by the user to initiate the network interaction to the reward account of the user.

9. A system for evaluating network-based interactions involving reward accounts, the system comprising:
a memory including a history of a reward account for a user, the reward account provided to the user by a merchant, wherein the history of the reward account includes a history of interactions involving the reward account and a history of access by the user to the reward account; and
a directory server in communication with the memory and with a merchant plug-in (MPI) associated with the merchant, the directory server configured to:
receive, from the MPI, a query related to a network-based interaction by the user at the merchant directed to the reward account of the user, the query including an identifier associated with the reward account;
generate a score associated with the query, based on the history of the reward account included in the memory;
determine whether the score satisfies a threshold;
direct a challenge to the user, at a communication device associated with the user, in response to the generated score failing to satisfy the threshold; and
transmit, to the MPI, a reply based on the generated score and/or the response to the challenge, thereby providing enhanced authentication of the user for the network-based interaction directed to the reward account of the user.

10. The system of claim 9, wherein the directory server is further configured to:
receive the history of the reward account from the merchant prior to receiving the query from the MPI; and
store the received history of the reward account in the memory.

11. The system of claim 9, wherein the challenge includes a request for a PIN or password associated with the user; and
wherein the directory server is further configured to determine whether the PIN or password provided by the user is consistent with a reference PIN or password for the user.

12. The system of claim 11, wherein the directory server is configured, in connection with generating the score, to generate the score further based on a type of merchant location involved in the network-based interaction.

13. The system of claim 11, wherein the query further includes a contact for the user; and
wherein the director server is configured, in connection with directing the challenge to the user, to direct the challenge to the user based on the contact included in the query.

14. The system of claim 9, wherein the query includes a data only request consistent with an EMV® 3-D Secure protocol.

15. The system of claim 9, wherein the directory server is configured, in connection with generating the score, to generate the score based on a velocity of interactions to the reward account and a last login by the user to the reward account.

16. The system of claim 9, further comprising the MPI; and
wherein the MPI is configured to:
receive a request for the score from the merchant, in response to an indication by the user to fund the network-based interaction with rewards from the reward account; and
in response to the request, transmit the query to the directory server.

17. A non-transitory computer-readable storage medium including executable instructions for evaluating network interactions involving reward accounts, which, when executed by a processor of a directory server, cause the processor to:
receive, from a merchant plug-in (MPI) associated with a merchant, a query related to a network interaction by a user at the merchant to fund a transaction at the merchant with rewards from a reward account of the user, the query including an identifier associated with the reward account;
generate a score associated with the query, based on a history of the reward account included in a data structure in communication with the processor, wherein the history of the reward account includes a history of interactions involving the reward account and a history of access by the user to the reward account;
determine whether the score satisfies a threshold;
direct a challenge to the user, at a communication device associated with the user, in response to the generated score failing to satisfy the threshold; and
transmit, to the MPI, a reply based on the generated score and/or the response to the challenge, thereby providing enhanced authentication of the user based on the network interaction by the user to fund the transaction at the merchant with rewards from the reward account of the user.

18. The non-transitory computer-readable storage medium of claim 17, wherein the executable instructions, when executed by the processor, further cause the processor to:
receive the history of the reward account from the merchant prior to receiving the query from the MPI; and
store the received history of the reward account in the data structure.

19. The non-transitory computer-readable storage medium of claim 18, wherein the challenge includes a request for a PIN or password associated with the user; and
wherein the executable instructions, when executed by the processor, further cause the processor to determine whether the PIN or password provided by the user is consistent with a reference PIN or password for the user.

20. The non-transitory computer-readable storage medium of claim 18, wherein the executable instructions, when executed by the processor in connection with generating the score, cause the processor to generate the score based on a velocity of interactions to the reward account and a last login by the user to the reward account.
